(19) United States
(12) Patent Application Publication
(10) Pub. No.: US 2026/0103352 A1
(43) Pub. Date: Apr. 16, 2026

(54) DEVICE FOR TRANSFERRING LIQUID

(71) Applicant: SEARAS AS, Bergen (NO)

(72) Inventor: Morten Aga, Bergen (NO)

(73) Assignee: SEARAS AS, Bergen (NO)

(21) Appl. No.: 19/113,077

(22) PCT Filed: Sep. 29, 2023
(86) PCT No.: PCT/NO2023/000004

§ 371 Date: Mar. 19, 2025

(30) Foreign Application Priority Data
Oct. 2, 2022 (NO) 20221048

(51) Int. Cl. B65G 53/54; A01K 63/02; B65G 53/30; B65G 53/56

(52) U.S. Cl. CPC B65G 53/54; A01K 63/02; B65G 53/30; B65G 53/56

(57) ABSTRACT

The invention discloses a distribution unit for the distribution of a liquid flow to one of several selectable outlets. A flexible element is arranged in the distribution unit, which can be rotated and positioned to direct the liquid flow to the chosen outlet.

### FIELD OF INVENTION

The present invention relates to a device for transferring liquid from a first tank to a second tank, i.e., for distributing a liquid flow in a pipe system, particularly a liquid flow comprising water with marine organisms, preferably fish. The challenge of transporting large fish through pipes poses a significant concern for fish welfare. The device according to the invention is specifically designed for the transfer of large fish.

### BACKGROUND OF THE INVENTION

In the aquaculture industry, there is a significant challenge in moving fish from one tank to another. Fish, along with the liquid they reside in, is transported through pipelines from one tank to another. Abrupt changes in the pipe direction expose the fish to stresses that can be harmful, and efforts are made to avoid such situations. Since the pipes are often of large dimensions, directional changes require substantial space and necessitate very large valves. Large valves pose challenges with tolerances critical to prevent leakage. Machining such large units is challenging, and the use of plastic materials may complicate meeting tight tolerance requirements. The invention addresses several of these challenges.

Given the current environmental challenges in open-sea aquaculture of marine species, an increasing portion of production must take place in closed tanks on land. The demand for increased production and yield means that tanks/containers become larger, and to utilize them maximally, fish must be moved from container to container as they grow. When fish are to be moved out of a tank, it is typically when the fish is at its largest, for example, destined for slaughter, or when the fish is to be distributed into several tanks for further growth.

When fish are transported for slaughter, the size of the fish typically ranges from 5 to 8 kg, and they are transported through pipelines with diameters reaching 0.5-0.6 m. Creating distribution valves of this size is demanding, especially when transporting live fish in the pipelines. The fish is easily injured if there are sharp edges or bends.

### OBJECT OF THE INVENTION

The purpose of the invention is to provide a device in the form of a valve that can be used for the movement of marine organisms, such as fish. The aim is for the device to distribute fish to various pipelines, i.e., there is one inlet to the valve, and the pipeline can be directed to one chosen among several outlets.

Furthermore, it is an objective of the invention that the valve should function under both negative and positive pressure in the pipelines and maintain this pressure without leakage. It is also a purpose of the invention that the valve can have several alternative selectable inlets, i.e., that liquid and marine organisms can be moved from one of several tanks to one tank (where the valve has only one outlet) or to one chosen among several tanks (where the valve has several selectable outlets).

Moreover, it is a purpose of the invention that the valve also includes a sorting unit, such as sorting fish based on size, and that fish of different sizes are directed out through several selectable outlets.

Transport pipes with negative pressure pose a challenge for multi-way valves. If a leak occurs, air will enter the water stream, leading to reduced water flow. For example, using the siphon principle, a valve that leaks air will reduce the siphon effect when the air that has leaked into the water stream must accompany the water down to the receiving container. The invention thus provides a concept that prevents leakage of air into the transport pipe when the pressure is lower than atmospheric pressure.

### SUMMARY OF THE INVENTION

The solution of the present invention pertains to a valve with a flexible piping element connecting one or more inlets to one or more outlets. The flexible piping element can be positioned between a chosen inlet and a chosen outlet. If the valve also includes a sorting unit, it is preferable that the piping element extends (downstream from the sorting unit) to two or more outlets.

In a first aspect, the present invention relates to a device for transferring liquid from a first tank to a second tank. The device includes a distribution unit arranged in a pipeline system between said tanks, where the distribution unit has one or more inlets and one or more outlets. It is characterized in that the distribution unit comprises an external valve housing in which at least one internal rotatable section is arranged, and where a flexible piping element is connected to one of the inlets and one of the outlets. At least one of the inlets or outlets is connected to the rotatable section, and the rotatable sections can be positioned at the desired inlet and/or outlet.

In some embodiments, the distribution unit includes one inlet and two or more outlets, where the flexible piping element is securely connected to the valve housing and to the rotatable section.

The rotatable section can be turned to direct the liquid flow from the flexible piping element through a selected outlet.

The valve housing can be filled with a liquid, preferably the same liquid but without marine organisms, which is directed through the device.

Shut-off valves can be placed on the outlets and/or inlets of the valve housing.

Seals are arranged in the contact surfaces between the internal rotatable section(s), the flexible piping element, and the outlets or inlets of the valve housing.

The pressure in the liquid in the valve housing can be adjusted higher or lower than the pressure in the flexible piping element. In one embodiment, the pressure in the valve housing is adjusted to be the same as the pressure in the flexible piping element, ensuring that the seals do not press on the contact surfaces, allowing the internal rotatable section to move easily.

The liquid in the mentioned tanks can include water and living marine species such as fish. The flexible piping element can be constructed in a way that, when bent sideways, it applies a rounded lateral deformation that does not harm the living marine organisms.

In a second aspect, the present invention relates to a method according to one of the above aspects for transferring liquid from a first tank to a second tank. As part of the pipeline system, a distribution unit is arranged to direct the liquid from one of one or more inlets to one of several outlets. The distribution unit comprises an external valve housing with one or more inlets and one or more outlets, and an internal rotatable section with a flexible piping element that is rotated to the desired inlet and/or outlet.

The valve housing can be filled with a liquid but without marine organisms, similar to what is in the flexible piping element.

The pressure in the valve housing can be adjusted higher and lower than the pressure in the flexible piping element.

In one embodiment, the pressure in the valve housing is adjusted to the same level as the pressure in the flexible piping element, allowing the internal rotatable section to move easily.

The liquid in the mentioned tanks can consist of a combination of liquid, such as water, and living marine organisms, such as fish.

### DESCRIPTION OF FIGURES

Preferred embodiments of the invention will be discussed in more detail in the following with reference to the accompanying figures, where:

FIG. 1: Schematic positioning of the flexible piping element from one inlet to one of three selectable outlet positions. The left figure shows the piping element positioned in outlet 30-3, while the right figure shows the piping element positioned in outlet 30-a.

FIG. 2: Schematic view of a lever to switch positions by pushing the rotatable section, and also pipelines for pressurizing the valve housing.

FIG. 3: Valves with shut-off valves on outlets.

FIG. 4: How the lever enables the rotation of the rotatable section.

### DESCRIPTION OF PREFERRED EMBODIMENTS OF THE INVENTION

The underlying principle of the present invention involves redirecting a flexible piping element within a valve 12 to allow it to be positioned at various inlets or outlets. Specific challenges addressed by the invention include the transportation of fish from a wellboat to a land-based facility. In this scenario, the fish are pumped from the boat into different tanks through large pipes, often with a diameter of 0.5-0.6 m. The large volume of water gently guides the fish through the pipes.

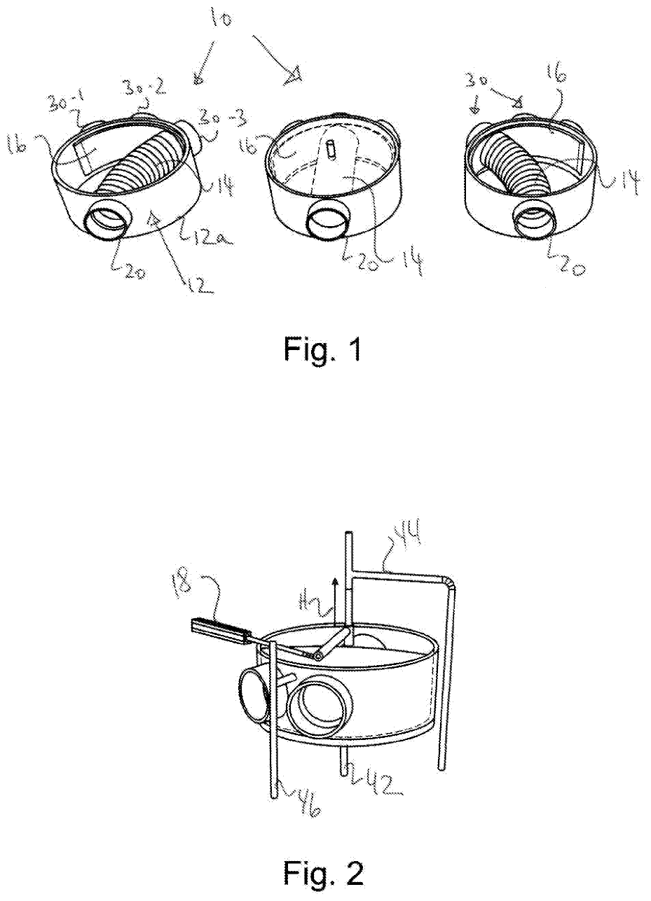

The invention pertains to a valve 12 that directs water and fish into a pipe 14, which can selectively go to different tanks. Such a valve is shown in FIG. 1. The valve 12 in FIG. 1 has one inlet 20 and three outlets 30-1, 30-2, and 30-3. A flexible piping element 14 can be positioned to connect the inlet to any of the outlets 30-1, 30-2, and 30-3, directing the fish and the liquid it resides in to the exits/outlets 30-1, 30-2, and 30-3. The valve is designed to provide a smooth and gentle swing of the flexible piping element 14 inside the valve housing 12 so that the fish is not harmed. In FIG. 1, an internally arranged rotatable section 16 is also visible within the valve. This rotatable section 16 can be pushed inside the valve housing, and the outlet of the flexible piping element 14 is attached to the rotatable section 16, configured such that displacement of the rotatable section 16 (relative to the valve housing) will position the flexible piping element 14 to one of the outlets 30-1, 30-2, 30-3. The unused outlets are closed off. The middle figure in FIG. 1 also shows parts of a lever 18 extending from the central axis of the rotatable section and out of the valve housing, allowing manual, pneumatic, or hydraulic rotation (displacement) of the central section with the rotatable section 16, as shown in FIGS. 2, 3, and 4.

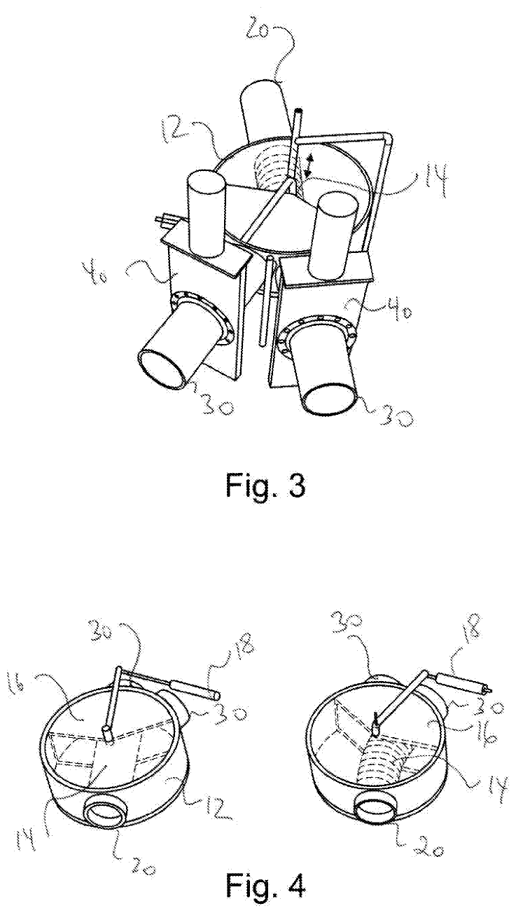

The valve 12 itself, as shown in FIG. 1, consists of a valve housing 12a with one inlet 20 and several outlets 30. FIG. 1 shows three outlets 30-1, 30-2, 30-3. FIG. 1 shows that inside the valve housing is a rotatable section 16 where a flexible piping element 14 is attached. Gaskets (not shown in the figures) are mounted on this rotatable section 16 to seal between it and the outlets 30 in the valve housing 12a. FIG. 3 schematically shows that there can be individual shut-off valves 40 on all outlets 30 from the valve housing 12. The shut-off valves 40 are used to prevent leaks, either of air that can be drawn into the valve in a vacuum application, e.g., from outlet pipes 30 where no water is flowing.

The valve housing 12 is normally filled with the same liquid that is transported through the flexible piping element 14. The valve housing 12 can be pressurized. FIGS. 2 and 3 show that the valve housing 12 can be pressurized by pumping liquid in through inlet 42. This will cause the rotatable section 16 to be pressed against the valve housing 12 since there is lower pressure on the outlet side of the rotatable section 16. The pressure can be regulated by placing an outlet 44 at a certain height above the valve housing 12. The height (H) of the liquid column 50 up to the outlet 44 will then reflect a pressure in the valve housing 16. This will cause the gaskets to tighten and create a tight connection in the pipe system through the valve 12. Additionally, supplying higher pressure to inlet 42 will fill the valve housing 12 with pressurized liquid, and thus, a leak would mean that liquid flows into the main liquid stream. The amount of liquid leaking from the valve housing 12 into the main liquid stream will be negligible compared to the amount flowing in the main pipe 14. If the pressure in the valve housing 12 is set equal to the pressure in the flexible piping element 14, the gaskets will be relieved, and the central section with the rotatable element 16 can be easily moved to another position. FIG. 2 also shows a supply line 46 for pressurizing the gaskets.

With reference to FIG. 1, we have indicated that, in the invention, a flexible piping element 16 is used to connect one inlet 20 to one selected outlet 30. By flexible, we mean that the piping element can bend somewhat, and preferably, the length of the piping element 16 can be adjusted slightly so that the piping element 16 can be easily positioned to one of the selected inlets 20 and outlets 30. In some embodiments of the invention, the valve has multiple alternative inlets 20 and one outlet 30. In other embodiments, the valve has both two or more inlets 20 and two or more outlets 30. The number of inlets 20 and outlets 30 that can be used is determined by the diameter of the pipelines into and out of the valve and the space available to rotate the rotatable section 16 to the relevant openings (inlets/outlets). The rotatable section 16 has the shape of a “cake slice” and extends from the central axis toward the inner periphery of the valve 12. The flexible piping element 14 is preferably securely connected to the rotatable section, allowing the displacement of the rotatable section 16 relative to the outer walls of the valve housing 12, enabling the positioning of the flexible piping element 14 to the desired inlet/outlet. If there are both multiple inlets and multiple outlets, two rotatable sections 16 are preferably arranged in the valve housing.

1. A device for transferring liquid from a first tank to a second tank, wherein the device comprises a distribution unit arranged in a pipe system between said tanks, wherein the distribution unit has one or more inlets and one or more outlets, wherein the distribution unit comprises an external valve housing in which at least one internal rotatable section is arranged, wherein a flexible stirring element is connected to one of the inlets and one of the outlets wherein at least one of the inlets or outlets is connected to the rotatable section, wherein the rotatable sections can be positioned to the desired inlet and/or outlet.

2. The device according to claim 1, wherein the distribution unit comprises one inlet and two or more outlets where the flexible stirring element is securely connected to the valve housing and to the rotatable section.

3. The device according to claim 2, wherein the rotatable section can be rotated to direct the liquid flow from the flexible stirring element out through the selected outlet.

4. The device according to claim 1, wherein the valve housing is filled with a liquid, preferably the same liquid but without marine organisms, which is passed through the device.

5. The device according to claim 1, wherein shut-off valves can be placed on the outlets and/or inlets of the valve housing.

6. The device according to claim 1, wherein gaskets are arranged in the contact surfaces between the internal rotatable section(s) with the flexible tube and the outlets or inlets from the valve housing.

7. The device according to claim 1, wherein the pressure in the liquid in the valve housing can be adjusted higher or lower than the liquid pressure in the flexible stirring element.

8. The device according to claim 7, wherein the liquid pressure in the valve housing is adjusted equal to the liquid pressure in the flexible stirring element so that the gaskets do not squeeze on the contact surfaces, designed so that the internal rotatable section can be easily moved.

9. The device according to claim 1, wherein the liquid in said tanks comprises water and living marine organisms, such as fish.

10. The device according to claim 1, wherein the flexible tube is constructed so that when bent sideways, a rounded lateral deformation is applied that does not harm the living marine organisms.

11. A method according to claim 1, for transferring liquid from the first tank to the second tank, wherein, as part of the pipe system, the distribution unit is arranged that directs the liquid from one of one or more inlets to one of several outlets, wherein the distribution unit comprises the external valve housing with one or more inlets and one or more outlets, and wherein the internal rotatable section with the flexible stirring element is rotated to the desired inlet and/or outlet.

12. The method according to claim 11, wherein the valve housing is filled with the liquid, but without marine organisms, similar to that in the flexible tube.

13. The method according to claim 11, wherein the liquid pressure in the valve housing can be adjusted higher and lower than the liquid pressure in the flexible tube.

14. The method according to claim 11, wherein the liquid pressure in the valve housing is adjusted to the same level as the liquid pressure in the flexible tube so that the internal rotatable section can be easily moved.

15. The method according to claim 11, wherein the liquid in said tanks consists of a combination of liquid, such as water, and living marine organisms, such as fish.
